(19) United States
(12) Patent Application Publication
(10) Pub. No.: US 2015/0211816 A1
(43) Pub. Date: Jul. 30, 2015

(54) ALUMINUM COMPOSITE MATERIAL, HEAT EXCHANGER, AND FLUX

(71) Applicant: Kabushiki Kaisha Kobe Seiko Sho (Kobe Steel, Ltd.), Kobe-shi, Hyogo (JP)

(72) Inventors: Nobuhiro Kobayashi, Hyogo (JP); Motohiro Horiguchi, Hyogo (JP); Koichi Sakamoto, Hyogo (JP); Toshiki Ueda, Tochigi (JP); Shimpei Kimura, Tochigi (JP); Takahiro Izumi, Tochigi (JP)

(73) Assignee: Kabushiki Kaisha Kobe Seiko Sho (Kobe Steel, Ltd.), Kobe-shi, Hyogo (JP)

(21) Appl. No.: 14/425,539

(22) PCT Filed: Aug. 14, 2013
(86) PCT No.: PCT/JP2013/071912

§ 371 Date: Mar. 3, 2015

(30) Foreign Application Priority Data
Sep. 4, 2012 (JP) 2012-194619

(51) Int. Cl. F28F 21/08; B23K 35/36; B23K 1/19; C01F 7/54; C22C 21/00

(52) U.S. Cl. CPC F28F 21/084; C01F 7/54; C22C 21/00; B23K 1/19; B23K 35/3605

(57) ABSTRACT

Disclosed is an aluminum composite material including an aluminum alloy material containing magnesium, and a bonding material formed by brazing using a flux, the bonding material being adapted to bond the aluminum alloy material thereto. In the aluminum composite material, the bonding material contains a magnesium-containing compound other than KMgF₃ and MgF₂. The present invention provides an aluminum composite material with satisfactory brazeability to an aluminum alloy material containing magnesium, a heat exchanger including the aluminum composite material, and a flux suitable for use in braze.

### TECHNICAL FIELD

The present invention relates to an aluminum composite material including an aluminum alloy material containing magnesium, and a bonding material formed by brazing using a flux and bonding the aluminum alloy material thereto, and to a heat exchanger including the same, and a flux therein.

### BACKGROUND ART

In recent years, interest in environmental issues has grown. For example, even in the automobile industry, reduction in weight has been underway for the purpose of improvement of fuel efficiency and the like. In response to the needs for the reduction in weight, the thinning and strengthening of an aluminum clad material for a vehicle heat exchanger (which is also called a brazing sheet and the like) have been increasingly studied. The above-mentioned clad material generally has a three-layered structure composed of a sacrificial material (e.g., Al—Zn based), a core material (e.g., Al—Si—Mn—Cu based), and a brazing material serving as a bonding material (e.g., Al—Si based). In order to increase the strength of the clad material, the strengthening by addition of magnesium (Mg) to the above-mentioned core material, that is, by precipitation of Mg₂Si have been studied.

A flux brazing method is widely used as the bonding of the clad materials to each other upon assembly of a heat exchanger and the like. The flux enhances the brazeability, and generally contains KAlF₄ as a principal component.

However, the clad material including the core material made of a magnesium-containing aluminum alloy inconveniently has the low brazeability in use of the conventional flux and therefore cannot make sufficient joint. This is because a magnesium in the core material is diffused into the flux on the surface of the brazing material during heating for brazing, and the magnesium reacts with the flux component to form a high-melting point compound (KMgF₃ and MgF₂), which consumes the flux component. For this reason, the flux for a magnesium-containing aluminum alloy and the aluminum composite material bonded using such a flux need to be developed in order to promote the reduction in weight of a vehicle heat exchanger and the like.

In such circumstances, as a flux that improves the brazeability of the clad material including a magnesium-containing aluminum alloy as the core material, (1) a flux which contains the conventional flux component and to which CsF is added (see JP 61-162295 A), and (2) a flux which contains the conventional flux component and to which CaF₂, NaF, or LiF is added (see JP 61-99569 A) have been studied.

However, (1) the CsF-added flux mentioned above is not appropriate for mass production and the like because Cs is very expensive, and thus has little practicability. On the other hand, (2) the CaF₂ and the like-added flux mentioned above improves the fluidity of the flux because the melting point of the flux is decreased by addition such a compound. Even in this kind of flux, however, the flux reacts with magnesium as usual, and thus does not sufficiently improve its brazeability. In general, it is known that the brazeability is enhanced by increasing the amount of application of the flux. However, the increase in amount of application causes high cost. From these reasons, it is required to develop the flux that enables excellent brazing at low cost, as well as the aluminum composite material sufficiently brazed (bonded) using such a flux and capable to achieve the low cost and the applicability to the mass production and the like.

Patent Literature 1: JP 61-162295 A

Patent Literature 2: JP 61-99569 A

### DISCLOSURE OF THE INVENTION

### Problems to be Solved by the Invention

The present invention has been made in view of the foregoing circumstances, and it is an object of the present invention to provide an aluminum composite material with satisfactory brazeability to an aluminum alloy material containing magnesium, a heat exchanger including the aluminum composite material and a flux suitable for use in braze.

### Means for Solving the Problems

The inventors have found that the magnesium diffused from an aluminum alloy into the flux reacts during brazing to generate a magnesium-containing compound other than high-melting point compounds of KMgF₃ and MgF₂, thereby suppressing an increase in a melting point, the consumption of the components of the flux required for the brazing, and the like, which makes it possible to improve the brazeability. The present invention has been made based on the findings.

That is, the present invention, which has been made in order to solve the above-mentioned problems, is directed to an aluminum composite material including:

an aluminum alloy material containing magnesium; and

a bonding material formed by brazing using a flux, the bonding material being adapted to bond the aluminum alloy material thereto,

wherein the bonding material contains a magnesium-containing compound other than KMgF₃ and MgF₂.

According to the aluminum composite material, the bonding material formed by brazing in this way and bonding the aluminum alloy material contains the magnesium-containing compounds other than KMgF₃ and MgF₂ that, which suppresses the increase in the melting point of the flux, the consumption of the necessary component in the flux during brazing, and the like. Thus, the aluminum composite material is sufficiently brazed at a bonded part, and thus can increase its strength and the like. In the aluminum composite material, the flux with excellent brazeability in this way is used, which can decrease the amount of used flux, leading to the reduction in cost and the applicability to the mass production and the like. The bonding material may bond the aluminum alloy materials to each other, or may bond the aluminum alloy material to another material.

The content of the magnesium-containing compound other than KMgF₃ and MgF₂ in the entire magnesium-containing compound in the bonding material is preferably 2% by mass or more. By setting the content of the compound to such a level, the sufficient brazing can be ensured to enhance the strength and the like of the bonded part.

The magnesium-containing compound other than the KMgF₃ and MgF₂ desirably contains fluorine and at least one element selected from the group consisting of sodium and potassium. Such a compound is considered to effectively suppress the increase in melting point of the flux and the consumption of the necessary component in the flux, thereby more improving the brazeability and the like.

The magnesium-containing compound other than the KMgF₃ and MgF₂ is preferably KMgAlF₆ and/or NaMgF₃. The presence of the above-mentioned compound in the bonded material can achieve more sufficient brazing.

The magnesium-containing compound other than the KMgF₃ and MgF₂ is preferably a reaction product formed between magnesium contained in the aluminum alloy material, and a component contained in the flux. In the aluminum composite material, the reaction with magnesium in this way produces the magnesium-containing compound other than KMgF₃ and MgF₂, which suppresses the consumption of the flux component required for the brazing and the formation of the high-melting point compound, thereby achieving the excellent brazing.

A heat exchanger according to the present invention includes the above-mentioned aluminum composite material. In the heat exchanger, the aluminum alloy material is well brazed as mentioned above.

A flux of the present invention is a flux for brazing of an aluminum alloy material containing magnesium, and is characterized by comprising:

a component for generating a magnesium-containing compound other than KMgF₃ and MgF₂ by reaction with magnesium.

The flux contains the component for generating the magnesium-containing compound other than KMgF₃ and MgF₂ by reaction with magnesium. When the aluminum alloy material containing magnesium is brazed, the magnesium can react with the above-mentioned component of the flux, thereby suppressing the formation of the KMgF₃ and MgF₂. Therefore, the use of this flux can suppress the increase in melting point as well as the consumption of the flux component required for the brazing due to the diffusion of the magnesium into the flux, thereby improving the brazeability.

### Effects of Invention

As mentioned above, the aluminum composite material of the present invention contains the magnesium-containing compound other than KMgF₃ and the MgF₂ in the bonding material bonding the aluminum alloy material, and thus has satisfactory brazeability. Therefore, the aluminum composite material can achieve both the increase in strength and the decrease in weight, and also reduce the cost. Thus, the aluminum composite material can be used in, for example, a vehicle heat exchanger and the like. The flux of the present invention can suppress the increase in its melting point and the consumption of the flux components required for brazing at the time of brazing, thereby improving the brazeability.

### BRIEF DESCRIPTION OF DRAWINGS

FIG. 1 is a schematic partial cross-sectional view showing an aluminum composite material according to one embodiment of the present invention.

FIG. 2 is a schematic partial cross-sectional view showing a clad material for forming the aluminum composite material shown in FIG. 1.

FIG. 3 is a schematic diagram showing an evaluation method in Examples.

FIG. 4 is a graph showing an evaluation result (1) in Examples.

FIG. 5 is a graph showing an evaluation result (2) in Examples.

FIG. 6 is a graph showing an evaluation result (3) in Examples.

### DESCRIPTION OF EMBODIMENTS

Preferred embodiments of an aluminum composite material and a flux according to the present invention will be described in detail below with reference to the accompanying drawings.

### [Aluminum Composite Material]

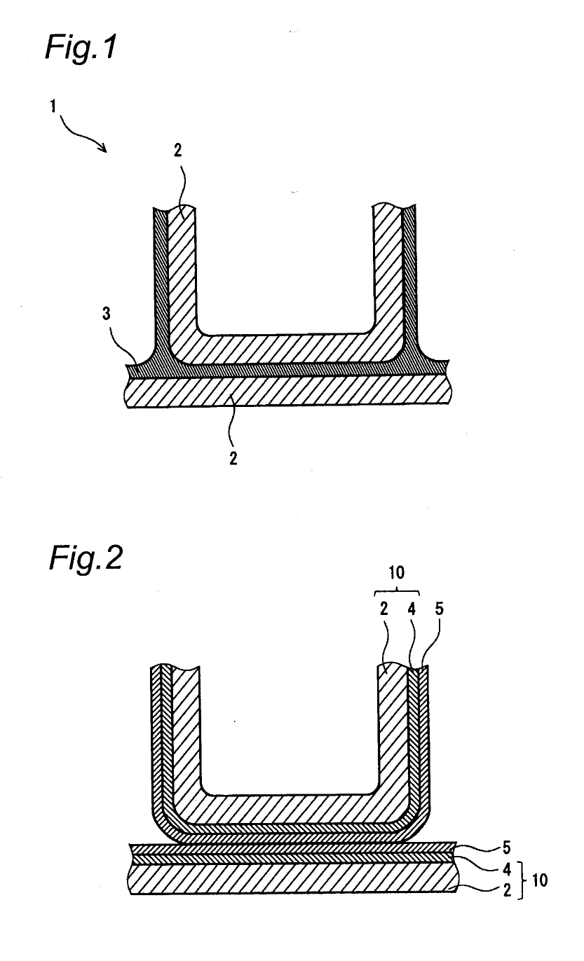

An aluminum composite material 1 shown in FIG. 1 includes an aluminum alloy material 2 containing magnesium, and a bonding material 3. The aluminum composite material 1 is brazed by heating a clad material 10 including the aluminum alloy material 2 in a state shown in FIG. 2. The above-mentioned clad material 10 may be formed by bending one sheet, or may be formed of a plurality of different sheets. First, the clad material 10 shown in FIG. 2 will be described in detail below.

The clad material 10 includes the aluminum alloy material 2 (core material) containing magnesium, and a blazing material 4 laminated on the surface of the aluminum alloy material 2. A flux layer 5 is laminated on the surface of the brazing material 4.

The aluminum alloy material 2 is formed of an aluminum alloy containing magnesium. The aluminum composite material 1 includes the aluminum alloy material 2 containing magnesium, and thus can achieve the strengthening and reduction in weight of the aluminum composite material 1.

An upper limit of magnesium content in the above aluminum alloy material 2 (aluminum alloy) is preferably 1.5% by mass, more preferably, 1.0% by mass, and most preferably 0.5% by mass. When the magnesium content in the aluminum alloy material 2 exceeds the upper limit, the brazing is not sometimes sufficiently. The lower limit of magnesium content in the aluminum alloy material 2 is not specifically limited, but for example, 0.01% by mass.

The brazing material 4 is not specifically limited, but can be formed by using the well-known material included in a conventional clad material. The brazing material 4 preferably has a melting point that is 10° C. to 100° C. higher than that of a [A] flux component of the flux mentioned later. Specifically, suitable materials for the brazing material can include an Al—Si alloy. More preferably, the Al—Si alloy whose Si content is 5 parts by mass or more and 15 parts by mass or less can be used. These Al—Si alloys (brazing material) may contain other components, such as Zn or Cu.

The flux layer 5 is a layer formed of flux. The details of the flux will be mentioned later. Formation methods of the flux layer 5 are not specifically limited, but can include, for example, a coating method of a powder, slurry or paste flux onto the surface of the brazing material 4, and the like.

A lower limit of a lamination amount of the flux forming the flux layer 5 is not specifically limited, and is preferably 0.5 g/m², and more preferably 1 g/m². By setting the lamination amount of the flux to the lower limit or more, the sufficient brazeability can be exhibited. On the other hand, an upper limit of the lamination amount of the flux is preferably 100 g/m², more preferably 60 g/m², still more preferably 20 g/m², and most preferably 10 g/m². By setting the lamination amount of the flux to the upper limit or less, the amount of use of the flux can be suppressed to achieve the reduction in cost, while maintaining the brazeability.

The size of the clad material 10 is not specifically limited, and the clad material 10 with the well-known size can be used. For example, the thickness of the clad material 10 can be set at, e.g., 0.1 mm or more and 2 mm or less. A manufacturing method of the clad material 10 is not specifically limited, and the clad material 10 can be manufactured by the well-known method.

The clad materials 10 are heated while the front surface sides of the clad materials 10 (the surfaces of the flux layers 5 respectively laminated) are in contact with each other as shown in FIG. 2. As a result, the aluminum alloy materials 2 is brazed (bonded) to each other to obtain the aluminum composite material 1 as shown in FIG. 1. Specifically, the brazing material 4 and the flux layer 5 of the clad material 10 are melted by heating the clad materials, and then cooled to be solidified, thereby forming the bonding material 3 (brazed part). The aluminum alloy material 2 is bonded by the bonding material 3.

The heating mentioned above is performed at a temperature lower than a melting point of the aluminum alloy material 2 (aluminum alloy) and higher than a melting point of the [A] flux component in the flux mentioned later (e.g., 580° C. or higher and 615° C. or lower). A rate of temperature increase in heating is in a range of, for example, about 10 to 100° C./min. The heating time is not specifically limited, and preferably short so as to reduce the amount of diffusion of magnesium that would inhibit the brazeability. The heating time is in a range of, for example, about 5 to 20 minutes.

The heating mentioned above is performed under the well-known environmental conditions, and preferably, under a non-oxidizing atmosphere, such as an inert gas atmosphere. From the viewpoint of suppressing oxidization, the concentration of oxygen during heating is preferably 1000 ppm or less, more preferably 400 ppm or less, and most preferably 100 ppm or less. A dew point under an environment during heating is preferably −35° C. or less.

The bonding material 3 is formed by melting the brazing material 4 and the flux layer 5 once and then solidifying them as mentioned above. The bonding material 3 contains a magnesium-containing compound other than KMgF₃ and MgF₂. In this way, the presence of the magnesium-containing compound other than KMgF₃ and MgF₂ in the bonding material 3 means the suppression of the formation of the KMgF₃ and MgF₂ which would be generated by the reaction between magnesium diffused from the aluminum alloy material 2 and the [A] flux component during brazing. That is, in the aluminum composite material 1, the increase in melting point of the flux and the consumption of the necessary flux component due to the formation of the KMgF₃ and MgF₂ are suppressed during brazing. Thus, the aluminum composite material 1 is sufficiently brazed at a bonded part, and thus can increase its strength and the like. In the aluminum composite material 1, the flux with excellent brazeability in this way is used, which can decrease the amount of used flux, leading to the reduction in cost and the applicability to the mass production and the like.

The positions where the magnesium-containing compounds other than the above-mentioned KMgF₃ and MgF₂ are present are preferably on the surface of the bonded material 3.

The magnesium-containing compound other than the KMgF₃ and MgF₂ is preferably a reaction product formed between magnesium contained in the aluminum alloy material 2, and a component contained in the flux. In the aluminum composite material 1, the reaction with magnesium in this way produces the magnesium-containing compound other than KMgF₃ and MgF₂, which suppresses the consumption of the flux component required for the brazing and the formation of the high-melting point compound, thereby achieving the more excellent brazing.

A lower limit of the content (preferably, the amount of formation; the same shall apply hereinafter) of the magnesium-containing compound other than KMgF₃ and MgF₂ in the entire magnesium-containing compound of the bonding material 3 (preferably, on the surface of the bonding material) is preferably 2% by mass, and more preferably by mass. By setting the content (amount of formation) of the magnesium-containing compound other than KMgF₃ and MgF₂ to such a level, the more sufficient brazing can be ensured to enhance the strength and the like of the bonded part. The upper limit of the content (amount of formation) is not specifically limited, and is preferably 90% by mass, and more preferably 100% by mass.

The content (amount of formation) of the compound in the bonding material 3 is a value determined by measurement on the surface of the bonding material 3 by an X-ray diffraction method (XRD) in a way mentioned in more detail in Examples.

The magnesium-containing compounds other than KMgF₃ and MgF₂ can include KMgAlF₆, NaMgF₃, LiMgF₃, LiMgAlF₆, NaMgAlF₆, Na₂MgAlF₇, MgCrF₆, MgMnF₆, MgSrF₄, MgSnF₆, MgTiF₆, MgVF₄, and the like.

Among them, a compound containing fluorine and at least one kind of element selected from the group consisting of sodium and potassium (e.g., KMgAlF₆, NaMgF₃, NaMgAlF₆, Na₂MgAlF₇, and the like) is preferable. Such a compound is considered to effectively suppress the increase in melting point of the flux, and to be capable of further improving the brazeability and the like.

In particular, among them, KMgAlF₆ and NaMgF₃ are preferable. The presence of the above-mentioned compound in the bonding material 3 can achieve the sufficient brazing.

A lower limit of the content (amount of formation) of the KMgAlF₆ in the entire magnesium-containing compound in the bonding material 3 is preferably 2% by mass, more preferably 3% by mass, and most preferably 15% by mass. By setting the content (amount of formation) of the KMgAlF₆ to the above-mentioned lower limit or more, the more sufficient brazing can be ensured to enhance the strength and the like of the bonded part. The upper limit of the content (amount of formation) of the compound is not specifically limited, and is preferably 90% by mass, and more preferably 100% by mass.

A lower limit of the content (amount of formation) of the NaMgF₃ in the entire magnesium-containing compound in the bonding material 3 is preferably 2% by mass, more preferably 5% by mass, and most preferably 20% by mass. By setting the content (amount of formation) of the NaMgF₃ to the above-mentioned lower limit or more, the more sufficient brazing can be ensured to enhance the strength and the like of the bonded part. The upper limit of the content (amount of formation) of the compound is not specifically limited, and is preferably 80% by mass.

The aluminum composite material 1 is used as components of a vehicle heat exchanger such as a radiator, an evaporator, and a condenser, and other metallic devices. The above-mentioned heat exchanger is the same as the well-known heat exchanger except for the presence of the aluminum composite material 1. In these heat exchangers, the clad material including the aluminum alloy material containing magnesium is used, thereby achieving strengthening and thinning of the aluminum composite material. Further, these heat exchangers have satisfactory brazeability, thus being firmly brazed.

### [Flux]

The flux of the present invention contains not only the [A] flux component, but also a [B] component that reacts with magnesium to generate a magnesium-containing compound other than KMgF₃ and MgF₂.

The flux contains the [B] component mentioned above. When the aluminum alloy material containing magnesium is brazed, the magnesium can react with the [B] component mentioned above, thereby suppressing the formation of the KMgF₃ and MgF₂. Therefore, the use of this flux can suppress the increase in melting point as well as the consumption of the [A] flux component required for the brazing due to the diffusion of the magnesium into the flux, thereby improving the brazeability.

### [A] Flux Component

The [A] flux component may be one included in a normal flux for brazing, and thus is not specifically limited. The [A] flux component melts prior to melting a component of the brazing material in a heating and temperature increasing process during brazing, removes an oxide film on the surface of the aluminum alloy material, and prevents reoxidation of aluminum by covering the surface of the aluminum alloy material.

The [A] flux component normally contains KAlF₄ as a principal component, and can include other fluorides such as KF, or K₂AlF₅, and hydrates such as K₂(AlF₅)(H₂O).

A content of KAlF₄ in the [A] flux components is not specifically limited, and is preferably 50% by volume or more, and more preferably 70% by volume or more.

The form of presence of the [A] flux component is not specifically limited, and preferably in the state of particle containing the [A] flux component, and more preferably in the state of particle not containing the [B] component (for example, particles consisting of the [A] flux component). The shape of the particle is not specifically limited, but can include a spherical form, an indefinite form, and the like. In use of the particles including the [A] flux component and the [B] component, the presence of the [B] component sometimes increases the melting point of the [A] flux component. For this reason, by making the particle of the [A] flux component and the particle of the [B] component separately, the increase in melting point of the [A] flux component can be suppressed, resulting in further improving the brazeability.

### [B] Component

The [B] component is not specifically limited as long as it reacts with magnesium to form the magnesium-containing compound other than KMgF₃ and MgF₂.

Examples of the [B] component mentioned above can include fluorides not containing K (potassium), such as AlF₃, TiF₃, CeF₃, BaF₂, NaF, LiF, CsF, CaF₂, and the like. One of or a mixture of two or more of these compounds can be used as the [B] component. Among them, a compound represented by XF₃ (provided that X is Al, Ti or Ce) is preferable, and AlF₃ is further preferable. Further, a mixture of XF₃ and NaF and/or LiF is more preferably used.

For example, the AlF₃ is considered to react with Mg and the like to form KMgAlF₆ and the like. The NaF is considered to react with Mg and the like to form NaMgF₃ and the like. The above-mentioned LiF is considered to react with Mg and the like to form LiMgAlF₆ and the like. The NaF and LiF also serve as a melting-point decreasing agent.

The upper limit of the content of the [B] component is not specifically limited, and is preferably 200 parts by mass, more preferably 100 parts by mass, and most preferably 60 parts by mass based on 100 parts by mass of the [A] flux component. When the content of the [B] component exceeds the upper limit, the content of the [A] flux component becomes relatively lower, so that the brazeability might be degraded.

The lower limit of the content of the [B] component is not specifically limited, and is preferably 1 part by mass, more preferably 2 parts by mass, and most preferably 5 parts by mass, based on 100 parts by mass of the [A] flux component. When the content of the [B] component is less than the lower limit, the effects of the present invention would not be sufficiently exhibited.

The form of presence of the [B] component is not specifically limited, and preferably, in the state of particles containing the [B] component, and more preferably, in the state of particles not containing the [A] component (e.g., particles consisting of the [B] component). The shape of the particle is not specifically limited, but can include a spherical form, an indefinite form, and the like. As mentioned above, by making the particle of the [A] flux component and the particle of the [B] component separately, the increase in melting point of the [A] flux component can be suppressed, resulting in improving the brazeability.

The flux may contain a component other than the [A] flux component and the [B] component in a range that does not interrupt the effects of the invention.

The form of the flux is not specifically limited, but normally powder. The flux may take other forms, e.g., a solid form, a paste form, and the like.

A method for manufacturing the flux is not specifically limited, but includes mixing the [A] flux component, the [B] component, and other components if needed at an appropriate ratio. The mixing methods can include, for example, (1) a method which includes simply mixing powdery components to obtain a powdery flux, (2) a method which includes mixing respective powdery components, heating and melting them in a crucible and the like, and then cooling them to obtain a solid or powdery flux, and (3) a method which includes suspending respective powdery components in a solvent such as water, to obtain the paste or slurry flux. As mentioned above, in order to obtain the flux containing the particles of the [A] flux component, and the particles of the [B] component, the methods (1) and (3) are preferable.

### OTHER EMBODIMENTS

The aluminum composite material, heat exchanger, and flux of the present invention are not limited to those disclosed in the above embodiments. For example, the aluminum composite material may be not only obtained by heating a clad material with a flux layer laminated thereon, but also obtained by bonding an aluminum alloy material and the like made of an aluminum alloy by use of a brazing material and a flux. Alternatively, the aluminum composite material may be obtained by bonding a clad material to a metal plate and the like other than the clad material.

In addition to the above-mentioned layered structure, the clad material may have a three or more layered structure, for example, a layered structure laminating a brazing material/a core material/a brazing material (three-layered structure with brazing material on both sides), or a layered structure laminating a brazing material/a core material/an intermediate layer/a brazing material (four-layered structure). Alternatively, the above-mentioned clad material may further include a sacrificial material which is laminated on the other surface of the core material and has an electrical potential lower than that of the core material.

### EXAMPLES

The present invention will be described in more detail below by way of Examples. However, the present invention is not limited to these Examples.

### Examples 1 to 14, and Comparative Example 1

The [A] flux component (100 parts by mass) and the [B] components (the kind and parts by mass of which were listed in Table 1) were added to 100 ml ion-exchanged water and suspended to produce each flux. The [A] flux component in the form of a powder containing 80% by volume of KAlF₄, and 20% by volume of K₂(AlF₅) (H₂O) was used. The [B] components of AlF₃, NaF, and LiF each of which was in the form of a powder were used.

A clad material including a sacrificial material, a core material made of an aluminum alloy containing 0.4% by mass of magnesium, and a brazing material (JIS 4045, clad ratio 10%) laminated on the surface of the core material was prepared. The thickness of the clad material was 0.4 mm. Each of the obtained fluxes was applied in an amount of 5 g/m² (in terms of solid contents) on the surface of the clad material (the surface of the brazing material) and then dried to laminate a flux layer thereon. The suspended flux was applied and the ion-exchanged water was dried and removed in this way, which enabled the uniform application of each powdery component.

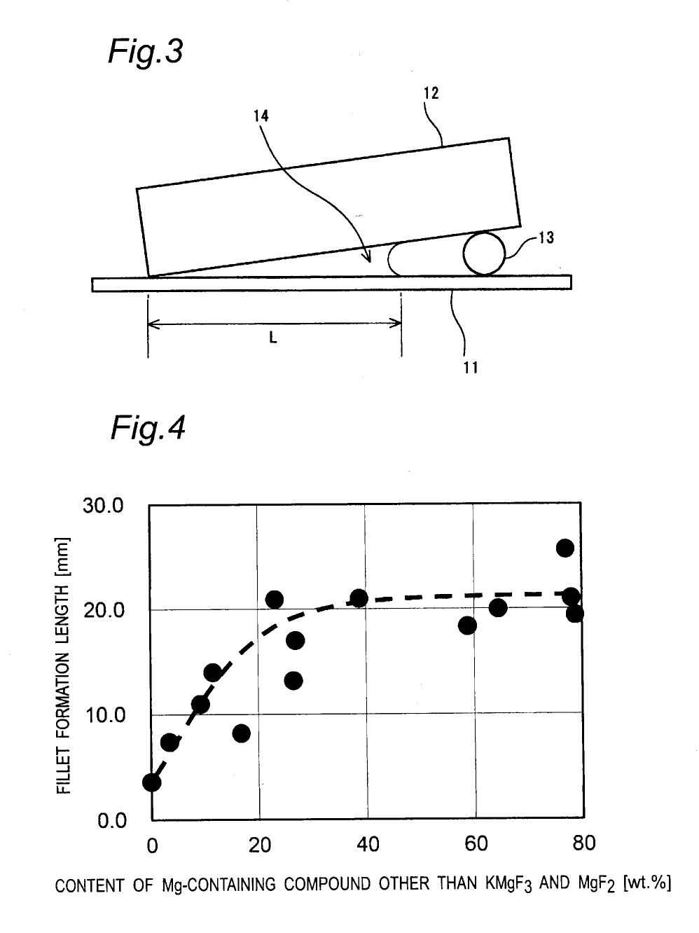

Each of obtained clad materials with the flux layer laminated thereon was brazed in the following way in conformance with Japan Light Metal Welding & Construction Association standard (LWS T8801), to obtain respective aluminum composite materials in Examples 1 to 14 and Comparative Example 1. A specific method will be mentioned below with reference to FIG. 3. The clad material as a lower plate 11 was placed with the flux layer facing upward as an upper surface thereof. A plate made of a 3003 Al alloy (base material) having 1.0 mm in thickness as an upper plate 12 was disposed on the upper surface of the lower plate. A rod-shaped spacer 13 made of SUS was sandwiched between the lower plate 11 and one end of the upper plate 12 to form a space between the lower plate 11 and the one end of the upper plate 12.

In the state mentioned above, brazing (a gap filling test) was carried out. Specifically, the lower plate 11 and the upper plate 12 were brazed by heating at 600° C. for 15 minutes under an atmosphere having a dew point of −40° C. and an oxygen concentration of 100 ppm or less. An average rate of temperature increase from room temperature to 600° C. was set at 50° C./min. In this way, the brazing material and the flux were melted and then solidified (hardened) to form a fillet 14 (bonding material) between the lower plate 11 and the upper plate 12.

### [Evaluation]

### (1) Fillet Formation Length

The length of the fillet 14 formed by brazing heating (fillet formation length L) was measured and regarded as an index of the brazeability. As the fillet formation length L is longer, the brazeability is excellent. The results of evaluation (the fillet formation length) are shown in Table 1.

### (2) Component and Content of Bonding Material (Brazed Part)

The surface of the fillet 14 formed by brazing heating (bonding material; brazed part) was analyzed in the following way, and the respective contents of the existing components were determined. The contents of the respective components are shown in Table 1. Since the brazing material and the flux before heating do not contain an Mg-containing compound, all the Mg-containing compounds in the fillet are considered as a product material generated by reaction with magnesium contained in the core material.

1. The surface of the fillet 14 was analyzed quantitatively by using a horizontal X-ray diffraction device SmartLab manufactured by Rigaku Corporation.

2. XRD spectra were obtained by the quantitative analysis, and peaks in the XRD spectra derived from the elements (Al and Si) in the aluminum alloy were removed. Then, the ratio of the content of each compound generated [% by mass] was determined.

3. Among the generated compounds, the content of each Mg-containing compound relative to all the Mg-containing compounds (KMgF₃, KMgAlF₆, MgF₂, NaMgF₃ and LiMgAlF₆) was calculated using the following formula (1).

W_{KMgF3}=100×W_{KMgF3,XRD}/W_{KMgF3,XRD}+W_{KMgAlF6,XRD}+W_{MgF2,XRD}+W_{NaMgF3,XRD}+W_{LiMgAlF6,XRD}) (1)

Wherein, W_{KMgF3} is the content [% by mass] of KMgF₃; W_{KMgF3,XRD}, W_{KMgAlF6,XRD}, W_{MgF2,XRD}, W_{NaMgF3,XRD} and W_{LiMgAlF6,XRD} are the contents [% by mass] of KMgF₃, KMgAlF₆, MgF₂, NaMgF₃, and LiMgAlF₆ determined by the above-mentioned section 2, respectively.

The above-mentioned formula (1) is a formula for determining the content [% by mass] of KMgF₃. The contents of other compounds were calculated in the same way.

TABLE 1

| | Blending quantity of | | | Fillet | | | | | | |
|---|---|---|---|---|---|---|---|---|---|---|
| | [B] component | | | formation | Components (except for Al and Si) | | | | | |
| | [Parts by mass] | | | length | [% by mass] | | | | | |
| | AlF₃ | NaF | LiF | [mm] | K₃AlF₆ | KMgF₃ | MgF₂ | KMgAlF₆ | Na₅Al₃F₁₄ | K₂NaAlF₆ |
| Comparative | 0.0 | 0.0 | 0.0 | 3.6 | 18.7 | 74.0 | 7.3 | 0.0 | 0.0 | 0.0 |
| Example 1 | | | | | | | | | | |
| Example 1 | 32.5 | 0.0 | 0.0 | 20.9 | 0.0 | 50.5 | 26.3 | 23.2 | 0.0 | 0.0 |
| Example 2 | 56.0 | 0.0 | 0.0 | 19.4 | 0.0 | 11.5 | 9.8 | 78.7 | 0.0 | 0.0 |
| Example 3 | 32.5 | 3.2 | 0.0 | 24.6 | 0.0 | 4.6 | 3.6 | 15.0 | 43.1 | 14.6 |
| Example 4 | 32.5 | 6.8 | 0.0 | 21.0 | 5.3 | 3.3 | 5.1 | 10.5 | 35.7 | 8.7 |
| Example 5 | 32.5 | 10.7 | 0.0 | 25.7 | 7.3 | 1.9 | 4.6 | 4.9 | 33.7 | 19.5 |
| Example 6 | 32.5 | 15.2 | 0.0 | 20.0 | 7.2 | 4.2 | 13.2 | 11.7 | 21.5 | 22.3 |
| Example 7 | 56.0 | 12.3 | 0.0 | 18.3 | 5.6 | 5.8 | 8.1 | 10.4 | 22.8 | 9.7 |
| Example 8 | 10.0 | 0.0 | 0.0 | 11.0 | 11.2 | 22.0 | 14.0 | 3.6 | 0.0 | 0.0 |
| Example 9 | 15.0 | 0.0 | 0.0 | 14.0 | 0.0 | 18.0 | 13.8 | 4.1 | 0.0 | 0.0 |
| Example 10 | 28.0 | 0.0 | 0.0 | 17.0 | 0.0 | 18.0 | 12.0 | 11.1 | 0.0 | 0.0 |
| Example 11 | 40.0 | 0.0 | 0.0 | 21.0 | 0.0 | 13.1 | 11.1 | 15.3 | 0.0 | 0.0 |
| Example 12 | 6.0 | 0.8 | 0.0 | 8.2 | 6.6 | 24.0 | 16.8 | 4.6 | 18.9 | 17.3 |
| Example 13 | 32.5 | 0.0 | 2.5 | 13.2 | 4.8 | 9.2 | 9.6 | 3.4 | 0.0 | 0.0 |
| Example 14 | 3.0 | 0.0 | 0.0 | 7.4 | 7.7 | 36.5 | 21.2 | 2.0 | 0.0 | 0.0 |

| | | | | Components [% by mass] (Value obtained | | | | | |
|---|---|---|---|---|---|---|---|---|---|
| | Components (except for Al and Si) | | | on the assumption that the total amount of | | | | | |
| | [% by mass] | | | Mg-containing product materials is set to 100%) | | | | | |
| | NaMgF₃ | NaAlF₄ | LiMgAlF₆ | KMgF₃ | MgF₂ | KMgAlF₆ | NaMgF₃ | LiMgAlF₆ | (*1) |
| Comparative | 0.0 | 0.0 | 0.0 | 91.1 | 8.9 | 0.0 | 0.0 | 0.0 | 0.0 |
| Example 1 | | | | | | | | | |
| Example 1 | 0.0 | 0.0 | 0.0 | 50.5 | 26.3 | 23.2 | 0.0 | 0.0 | 23.2 |
| Example 2 | 0.0 | 0.0 | 0.0 | 11.5 | 9.8 | 78.7 | 0.0 | 0.0 | 78.7 |
| Example 3 | 19.2 | 0.0 | 0.0 | 10.8 | 8.5 | 35.4 | 45.4 | 0.0 | 80.8 |
| Example 4 | 19.5 | 11.8 | 0.0 | 8.7 | 13.3 | 27.3 | 50.7 | 0.0 | 78.1 |
| Example 5 | 17.0 | 11.1 | 0.0 | 6.8 | 16.2 | 17.2 | 59.8 | 0.0 | 77.0 |
| Example 6 | 19.9 | 0.0 | 0.0 | 8.6 | 26.9 | 23.9 | 40.6 | 0.0 | 64.5 |
| Example 7 | 9.3 | 28.3 | 0.0 | 17.1 | 24.1 | 31.0 | 27.8 | 0.0 | 58.8 |
| Example 8 | 0.0 | 0.0 | 0.0 | 55.6 | 35.4 | 9.1 | 0.0 | 0.0 | 9.1 |
| Example 9 | 0.0 | 0.0 | 0.0 | 50.1 | 38.4 | 11.4 | 0.0 | 0.0 | 11.4 |
| Example 10 | 0.0 | 0.0 | 0.0 | 43.8 | 29.2 | 27.0 | 0.0 | 0.0 | 27.0 |
| Example 11 | 0.0 | 0.0 | 0.0 | 33.2 | 28.1 | 38.7 | 0.0 | 0.0 | 38.7 |
| Example 12 | 3.6 | 5.3 | 0.0 | 49.0 | 34.3 | 9.4 | 7.3 | 0.0 | 16.7 |
| Example 13 | 0.0 | 0.0 | 3.4 | 35.9 | 37.5 | 13.3 | 0.0 | 13.3 | 26.6 |
| Example 14 | 0.0 | 0.0 | 0.0 | 61.1 | 35.5 | 3.4 | 0.0 | 0.0 | 3.4 |

(*1) Mg-containing compound other than KMgF₃ and MgF₂

The relationships between the components included in the bonding material and the fillet formation lengths are shown in FIGS. 4 to 6.

FIG. 4 is a graph showing the relationship between the contents (% by mass) of Mg-containing compounds other than KMgF₃ and MgF₂ relative to all the Mg-containing compounds, and the fillet formation lengths (mm).

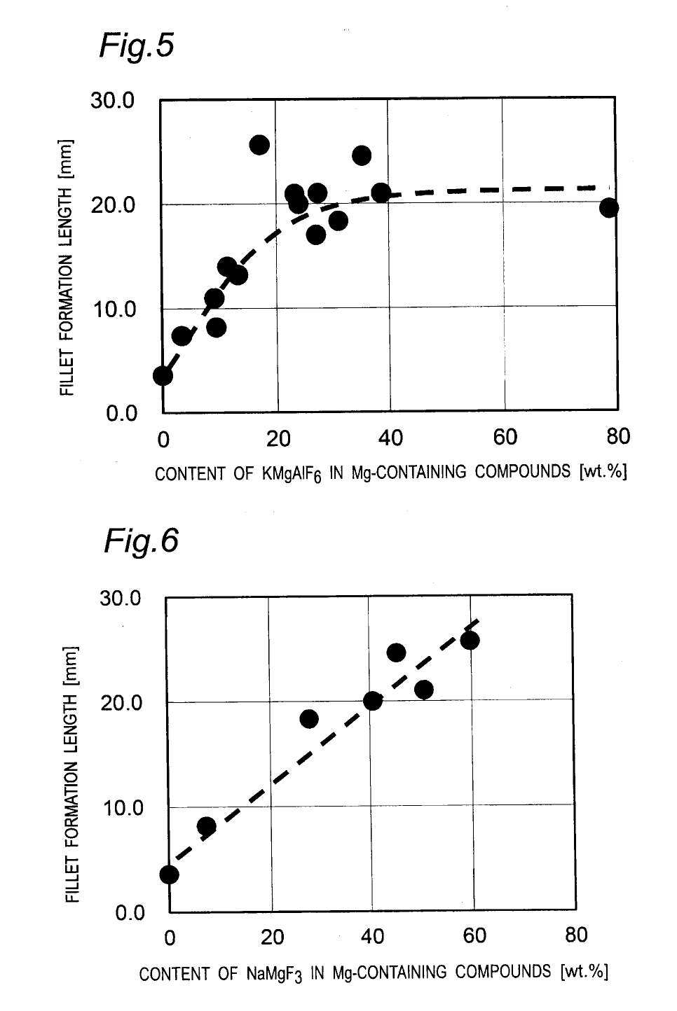

FIG. 5 is a graph showing the relationship between the contents (% by mass) of KMgAlF₆ relative to all the Mg-containing compounds, and the fillet formation lengths (mm).

FIG. 6 is a graph showing the relationship between the contents (% by mass) of NaMgF₃ relative to all the Mg-containing compounds, and the fillet formation lengths (mm).

As shown in Table 1 and FIG. 4, it is found that the aluminum composite materials in Examples contain the magnesium-containing compound other than KMgF₃ and MgF₂ in the bonding material (the fillet), and have a longer fillet formation length and excellent brazeability.

In particular, as shown in FIGS. 5 and 6, it is found that the content of each of KMgAlF₆ and NaMgF₃ relative to all the Mg-containing compounds is correlated highly with the fillet formation length, and that as the contents (amounts of formation) of these compounds are increased, the brazeability is improved.

### INDUSTRIAL APPLICABILITY

The aluminum composite material of the present invention has satisfactory brazeability, and is suitable for use in the vehicle heat exchangers and the like made of the aluminum alloy.

### DESCRIPTION OF REFERENCE NUMERALS

1 Aluminum composite material
2 Aluminum alloy material
3 Bonding material
4 Brazing material
5 Flux layer
10 Clad material
11 Lower plate
12 Upper plate
13 Spacer
14 Fillet
L Fillet formation length

1. An aluminum composite material comprising:
an aluminum alloy material comprising magnesium, and
a bonding material formed by brazing with a flux, the bonding material being adapted to bond the aluminum alloy material thereto,
wherein the bonding material comprises a magnesium-containing compound other than KMgF₃ and MgF₂.

2. The aluminum composite material according to claim 1, wherein a content of the magnesium-containing compound other than KMgF₃ and MgF₂ relative to a total content of magnesium-containing compounds in the bonding material is 2% by mass or more.

3. The aluminum composite material according to claim 1, wherein the magnesium-containing compound other than the KMgF₃ and MgF₂ comprises fluorine and at least one element selected from the group consisting of sodium and potassium.

4. The aluminum composite material according to claim 3, wherein the magnesium-containing compound other than the KMgF₃ and MgF₂ comprises KMgAlF₆ and/or NaMgF₃.

5. The aluminum composite material according to claim 1, wherein the magnesium-containing compound other than the KMgF₃ and MgF₂ is a reaction product formed between magnesium contained in the aluminum alloy material, and a component contained in the flux.

6. A heat exchanger comprising the aluminum composite material according to claim 1.

7. A flux comprising:
a component adapted for generating a magnesium-containing compound other than KMgF₃ and MgF₂ by reaction with magnesium.

8. The aluminum composite material according to claim 1, wherein the magnesium-containing compound other than the KMgF₃ and MgF₂ comprises fluorine and sodium.

9. The aluminum composite material according to claim 1, wherein the magnesium-containing compound other than the KMgF₃ and MgF₂ comprises fluorine and potassium.

10. The aluminum composite material according to claim 1, wherein the magnesium-containing compound other than the KMgF₃ and MgF₂ comprises fluorine, sodium and potassium.

11. The aluminum composite material according to claim 3, wherein the magnesium-containing compound other than the KMgF₃ and MgF₂ comprises KMgAlF₆.

12. The aluminum composite material according to claim 3, wherein the magnesium-containing compound other than the KMgF₃ and MgF₂ comprises NaMgF₃.

13. The aluminum composite material according to claim 3, wherein the magnesium-containing compound other than the KMgF₃ and MgF₂ comprises KMgAlF₆ and NaMgF₃.
